(19) United States
(12) Patent Application Publication
(10) Pub. No.: US 2008/0159197 A1
(43) Pub. Date: Jul. 3, 2008

(54) NETWORK DEVICE AND PACKET TRANSMITTING METHOD THEREOF

(75) Inventors: CHING-I LU, Tu-Cheng (TW); YU-CHENG LIN, Tu-Cheng (TW); CHENG-YI HSIEH, Tu-Cheng (TW); IRAWAN KUNCORO, Tu-Cheng (TW); CHIH-HUNG WENG, Tu-Cheng (TW); CHIH-LUNG CHEN, Tu-Cheng (TW); MENG-SHU LEE, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/836,802

(22) Filed: Aug. 10, 2007

(30) Foreign Application Priority Data
Dec. 27, 2006 (CN) 200610157762.8

(51) Int. Cl. H04L 12/56

(52) U.S. Cl. 370/312; 370/389

(57) ABSTRACT

A network device (20) for connecting an Ethernet terminal device (10) to a communication network (30) includes a database (23), a first transceiving module (21), a second transceiving module (26), and a destination address determining module (25). The database is used for saving a reference address. The first transceiving module is connected to the Ethernet terminal device. The second transceiving module is connected to the communication network, and is used for receiving a packet sent by the communication network and forwarding the packet. The destination address determining module is used for determining whether a destination address of the packet matches with the reference address saved in the database. If the destination address of the packet matches with the reference address saved in the database, the first transceiving module sends the packet to the Ethernet terminal device.

### BACKGROUND OF THE INVENTION

1. Field of the Invention

The invention relates to network devices, and particularly to a network device and packet transmitting method thereof.

2. Description of Related Art

With fast development of electronic communication networks, more efforts are paid to improving packet transmitting efficiency of a network device. However, the speed limit of processing packets can decrease the packet transmitting efficiency of the network device. Conventionally the network device forwards packets via a bridge module of the network device, and the bridge module must parse each packet for getting a destination address thereof and correspondingly forwards the packet to the destination address, which results in slow speed of processing packets of the network device.

### SUMMARY OF THE INVENTION

One embodiment of the invention provides a network device for transmitting data. The network device is for connecting an Ethernet terminal device to a communication network, including a database, a first transceiving module, a second transceiving module, and a destination address determining module. The database is used for saving a reference address. The first transceiving module is connected to the Ethernet terminal device. The second transceiving module is connected to the communication network, and is used for receiving a packet sent by the communication network and forwarding the packet. The destination address determining module is used for determining whether a destination address of the packet matches with the reference address saved in the database. If the destination address of the packet matches with the reference address saved in the database, the first transceiving module sends the packet to the Ethernet terminal device.

Another embodiment of the invention provides a method for transmitting data. The method includes receiving a data packet, the packet comprising a destination address; determining whether the destination address of the packet matches with a reference address saved in a database; and sending the packet to an Ethernet terminal device via an Ethernet transceiving module if the packet matches with the reference address corresponding to the Ethernet terminal device saved in the database.

Other advantages and novel features will become more apparent from the following detailed description when taken in conjunction with the accompanying drawings, in which:

### BRIEF DESCRIPTION OF THE DRAWINGS

FIG. 1 is a block diagram of a network device in accordance with an exemplary embodiment of the invention;

FIG. 2 shows a block diagram of a network device in accordance with another exemplary embodiment of the invention;

FIG. 3 shows a flow chart of a method for transmitting packets in accordance with a further exemplary embodiment of the invention; and

FIG. 4 shows a flow chart of a method for transmitting packets in accordance with yet another exemplary embodiment of the invention.

### DETAILED DESCRIPTION OF THE INVENTION

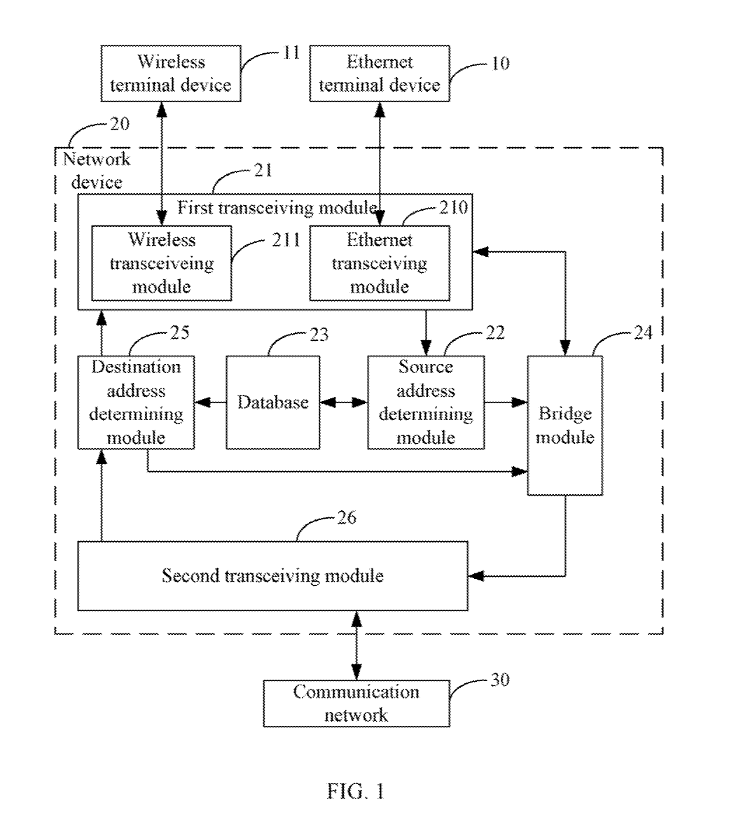

FIG. 1 is a block diagram of a network device 20 in accordance with an exemplary embodiment of the invention. In the exemplary embodiment, an Ethernet terminal device 10, a wireless terminal device 11, or other communication devices, can connect to a communication network 30 by way of the network device 20. The Ethernet terminal device 10 is connected to the network device 20 via an Ethernet port (not shown). The wireless terminal device 11 is connected to the network device 20 via a wireless communication port. In the exemplary embodiment, the Ethernet terminal device 10, the wireless terminal device 11 or other communication devices can send packets to the communication network 30 or receive packets from the communication network 30 via the network device 20. In the exemplary embodiment, the Ethernet terminal device 10 and the wireless terminal device 11 may be computers or other communication devices, and the network device 20 may be an asymmetrical digital subscriber line (ADSL) modem.

In the exemplary embodiment, the network device 20 includes a first transceiving module 21, a source address determining module 22, a database 23, a bridge module 24, a destination address determining module 25, and a second transceiving module 26.

The database 23 is used for saving a source address of a packet sent by the Ethernet terminal device 10. In the exemplary embodiment, the database 23 saves the source address of the latest packet sent by the Ethernet terminal device 10 as a reference source address corresponding to the Ethernet terminal device 10.

The first transceiving module 21 is connected to the Ethernet terminal device 10 and the wireless terminal device 11, and is used for receiving the packets sent by the Ethernet terminal device 10 and the wireless terminal device 11, for sending the packets sent by the Ethernet terminal device 10 to the source address determining module 22 and sending the packets sent by the wireless terminal device 11 to the bridge module 24. In the exemplary embodiment, the first transceiving module 21 includes an Ethernet transceiving module 210 and a wireless transceiving module 211. The Ethernet transceiving module 210 is connected to the Ethernet terminal device 10, and is used for receiving the packets sent by the Ethernet terminal device 10 and sending the packets to the source address determining module 22. The wireless transceiving module 211 is connected to the wireless terminal device 11, and is used for receiving the packets sent by the wireless terminal device 11 and for sending the packets to the bridge module 24.

The source address determining module 22 is connected to the Ethernet transceiving module 210, the database 23, and the bridge module 24, and is used for receiving a newly arrived packet sent by the Ethernet transceiving module 210, and for parsing the packet for getting the source address thereof, and determining whether the source address of the newly arrived packet matches with the reference source address saved in the database 23. In the exemplary embodiment, if the source address of the newly arrived packet matches with the reference source address saved in the database 23, the source address determining module 22 sends the new arrived packet to the bridge module 24. If the source address of the newly arrived packet does not match with the reference source address, the source address determining module 22 saves the source address of the newly arrived packet in the database 23 as a new reference source address, and sends the packet to the bridge module 24.

The bridge module 24 is connected to the Ethernet transceiving module 210, the wireless transceiving module 211, and the source address determining module 22, and is used for receiving the packets sent by the Ethernet transceiving module 210 or the wireless transceiving module 211, parsing the packets for getting destination addresses thereof, and forwarding the packets to the corresponding destination addresses.

The second transceiving module 26 is connected to the bridge module 24 and the communication network 30, and is used for receiving the packets sent by the bridge module 24 and sending the packets to the communication network 30 according to the destination addresses thereof. In the exemplary embodiment, the second transceiving module 26 is further used for receiving packets sent by the communication network 30, and sending the packets to the destination address determining module 25.

The destination address determining module 25 is connected to the second transceiving module 26, the first transceiving module 21, the bridge module 24, and the database 23. The destination address determining module 25 is used for receiving a packet sent by the second transceiving module 26, parsing the packet for getting the destination address thereof, and determining whether the destination address of the packet matches with the reference source address saved in the database 23. In the exemplary embodiment, if the destination address of the packet matches with the reference source address saved in the database 23, the destination address determining module 25 sends the packet to the Ethernet transceiving module 210. If the destination address of the packet does not match with the reference source address, the destination address determining module 25 sends the packet to the bridge module 24.

In the exemplary embodiment, the bridge module 24 is further used for receiving the packet sent by the destination address determining module 25, and is used for parsing the packet for getting the destination address thereof, and sending the packet to the Ethernet transceiving module 210 or the wireless transceiving module 211 according to the destination address.

In the exemplary embodiment, the Ethernet transceiving module 210 is further used for receiving the packet sent by the destination address determining module 25 and the bridge module 24, and for sending the packet to the Ethernet terminal device 10. The wireless transceiving module 211 is further used for receiving the packet sent by the bridge module 24 and for sending the packet to the wireless terminal device 11.

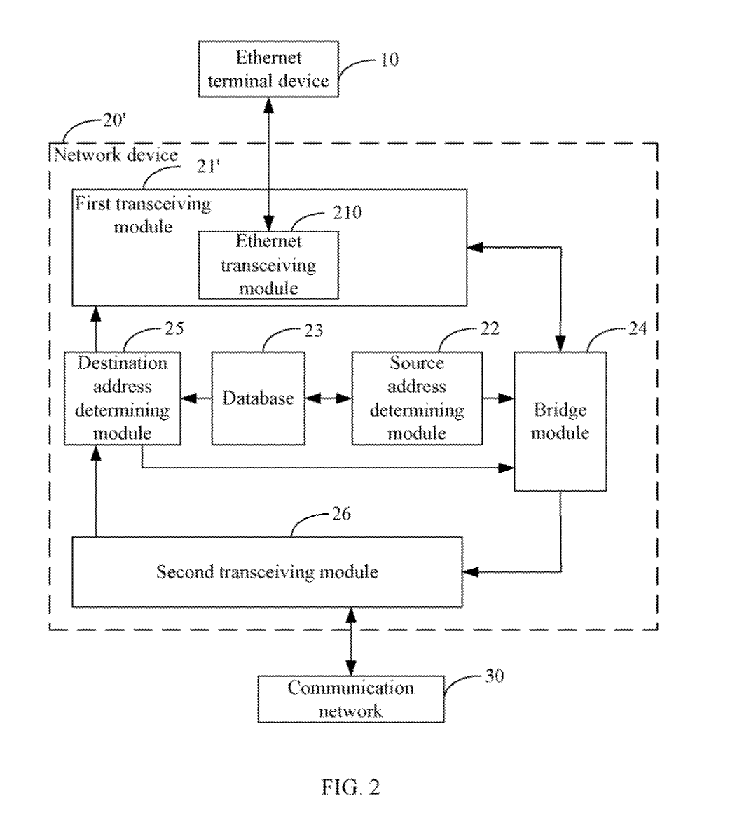

FIG. 2 shows a block diagram of a network device 20′ including a first transceiving module 21′ in accordance with another exemplary embodiment. In the exemplary embodiment, the structure of the network device 20′ is similar to that of the network device 20 except that the first transceiving module 21′ only includes the Ethernet transceiving module 210. For simplicity, the network device 20′ is not described here in detail.

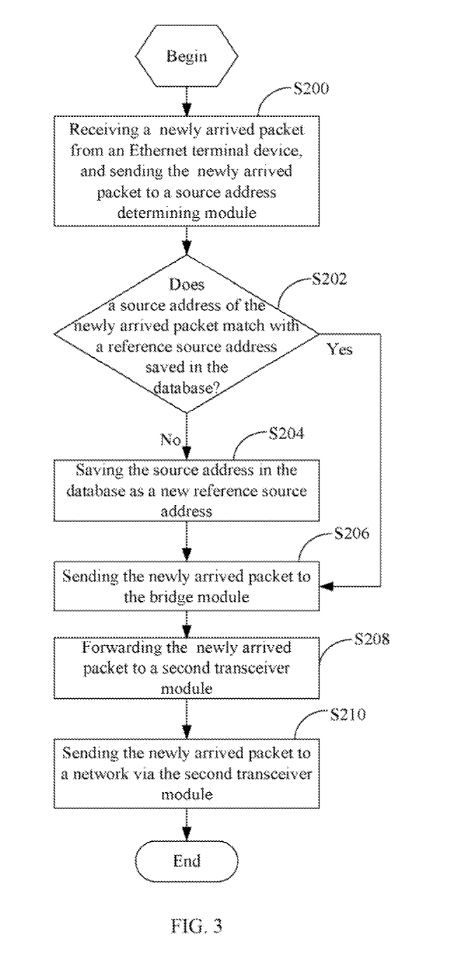

FIG. 3 shows a flow chart of a method for transmitting packets in accordance with a further exemplary embodiment of the invention. In the exemplary embodiment, in step S200, the Ethernet transceiving module 210 receives a newly arrived packet sent by the Ethernet terminal device 10, and sends the newly arrived packet to the source address determining module 22.

In step S202, the source address determining module 22 parses the newly arrived packet for getting a source address thereof, and determines whether the source address of the newly arrived packet matches with a reference source address saved in the database 23. In the exemplary embodiment, the reference source address saved in the database 23 is a MAC address of the Ethernet terminal device 10.

If the source address of the newly arrived packet does not match with the reference source address saved in the database 23, in step S204, the source address determining module 22 saves the source address of the newly arrived packet in the database 23 as a new reference source address. Then in step S206, the source address determining module 22 sends the newly arrived packet to the bridge module 24.

If the source address of the newly arrived packet matches with the reference source address saved in the database 23, in step S206, the source address determining module 22 sends the newly arrived packet to the bridge module 24 directly.

In step S208, the bridge module 24 receives the newly arrived packet, and forwards the newly arrived packet to the second transceiving module 26. In the exemplary embodiment, the bridge module 24 parses the new packet for getting a destination address thereof.

In step S210, the second transceiving module 26 receives the newly arrived packet, and sends it to a destination according to the destination address.

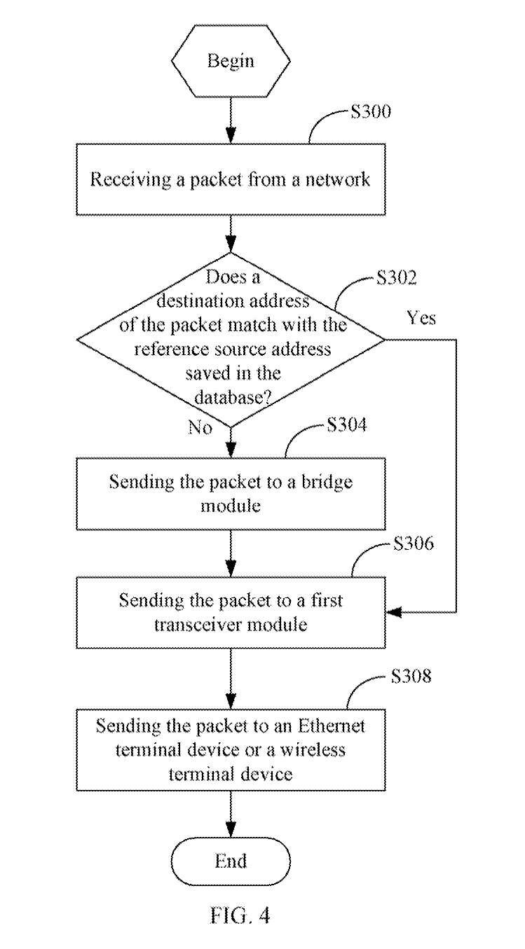

FIG. 4 shows a flow chart of a method for transmitting packets in accordance with yet another exemplary embodiment of the invention. In the exemplary embodiment, in step S300, the second transceiving module 26 receives a packet sent by the communication network 30, and sends the packet to the destination address determining module 25.

In step S302, the destination address determining module 25 parses the packet for getting a destination address thereof, and determines whether the destination address of the packet matches with the reference source address saved in the database 23. In the exemplary embodiment, the reference source address in the database 23 corresponds to the Ethernet terminal device 10.

If the destination address of the packet does not match with the reference source address saved in the database 23, in step S304, the destination address determining module 25 sends the packet to the bridge module 24.

In step S306, the bridge module 24 forwards the packet to the first transceiving module 21. In the exemplary embodiment, the bridge module 24 parses the packet for getting the destination address of the packet thereof, and forwards the packet to the Ethernet transceiving module 210 or the wireless transceiving module 211 according to the destination address.

In step S308, the first transceiving module 21 sends the packet to the Ethernet terminal deceive 10 or the wireless transceiving module 11. In the exemplary embodiment, the Ethernet transceiving module 210 sends the packet to the Ethernet terminal device 10, and the wireless transceiving module 211 sends the packet to the mobile terminal device 11.

If the destination address of the packet matches with the reference source address saved in the database 23, in step S306, the destination address determining module 25 sends the packet to the first transceiving module 21. In the exemplary embodiment, the destination address determining module 25 sends the packet to the Ethernet transceiving module 210, then turns to step S308, in which the Ethernet transceiving module 210 sends the packet to the Ethernet terminal device 10.

The network device 20 and the method for transmitting data make the network device 20 forward a packet without the bridge module 24, therefore, the network device 20 speeds up the rate of transmitting data, particular the rate of transmitting packets to the Ethernet terminal device 10, and increases the efficiency of transmitting packets.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device for connecting an Ethernet terminal device to a communication network, the network device comprising:
a database for saving a reference address;
a first transceiving module connected to the Ethernet terminal device;
a second transceiving module connected to the communication network, for receiving a packet sent by the communication network, and forwarding the packet; and
a destination address determining module for determining whether the destination address of the packet matches with the reference address saved in the database;
wherein if the destination address of the packet matches with the address saved in the database, the first transceiving module sends the packet to the Ethernet terminal device.

2. The network device of claim 1, further comprising a bridge module, connected to the destination address determining module and the second transceiving module, for getting the destination address of the packet if a destination address of the packet does not match with the address saved in the database.

3. The network device of claim 2, wherein the first transceiving module is further used for sending the packet to the corresponding destination address.

4. The network device of claim 1, wherein the first transceiving module further comprises an Ethernet transceiving module, for forwarding the packet to the Ethernet terminal device.

5. The network device of claim 4, further comprising a source address determining module, for parsing the packet sent by the Ethernet transceiving module for getting a source address thereof, and determining whether the source address of the packet matches with the reference address saved in the database.

6. The network device of claim 5, wherein the source address determining module is further used for saving the source address of the packet in the database as a new reference address if the source address of the packet does not match with the address saved in the database.

7. The network device of claim 6, further comprising a bridge module, connected to the Ethernet transceiving module, the source address determining module, the destination address determining module, and the second transceiving module, for parsing the packet sent by the source address determining module for getting a destination address of the packet sent by the source address determining module, and forwarding the packet to the second transceiving module via the destination address.

8. The network device of claim 7, wherein the source address determining module is further used for sending the packet to the bridge module if the source address of the packet matches with the address saved in the database.

9. The network device of claim 8, wherein the destination address determining module is further used for sending the packet to the bridge module if the destination address of the packet does not match with the address saved in the database.

10. The network device of claim 9, wherein the bridge module is further used for parsing the packet sent by the destination determining module for getting a destination address, and forwarding the packet to the destination address.

11. The network device of claim 1, wherein the first transceiving module comprises an Ethernet transceiving module, for sending the packet sent by the destination address determining module to the Ethernet terminal device.

12. A method for transmitting a packet, comprising the steps of:
receiving the packet, the packet comprising a destination address;
determining whether the destination address of the packet matches with a reference address saved in a database; and
sending the packet to an Ethernet terminal device via an Ethernet transceiving module if the packet matches with the reference address corresponding to the Ethernet terminal device saved in the database.

13. The method for transmitting data of claim 12, further comprising:
sending the packet to a bridge module, if the packet does not match with the reference address corresponding to the Ethernet terminal device saved in the database.

14. The method for transmitting data of claim 13, further comprising the step of parsing the packet for getting a destination address of the packet via the bridge module.

15. The method for transmitting data of claim 14, further comprising the step of sending the packet to the Ethernet transceiving module for sending to the Ethernet terminal device corresponding to the destination address of the packet.

16. The method for transmitting data of claim 12, further comprising the steps of:
receiving the packet sent by the Ethernet terminal device;
determining whether a source address of the packet sent by the Ethernet terminal device matches with a reference address saved in a database; and
saving the source address of the packet sent by the Ethernet terminal device in the database as a new reference address and sending the packet to a bridge module, if the source address of the packet does not match with the reference address saved in the database.

17. A method for transmitting a packet, comprising the steps of:
receiving the packet sent by an Ethernet terminal device, and sending the packet to a source address determining module;
determining whether a source address of the packet sent by the Ethernet terminal device matches with a reference address saved in a database; and
saving the source address of the packet sent by the Ethernet terminal device in the database as a new reference address and sending the packet to a bridge module, if the source address of the packet does not match with the reference address saved in the database.

18. The method for transmitting data of claim 17, further comprising:
sending the packet to the bridge module if the source address of the packet matches with the reference address saved in the database.

19. The method for transmitting data of claim 17, further comprising:
parsing the packet sent by the Ethernet terminal device for getting a destination address;
forwarding the packet to a second transceiving module via the destination address; and
sending the packet to a communication network via the second transceiving module.

20. The method for transmitting data of claim 17, further comprising the steps of:
receiving the packet from a net work, the packet comprising a destination address;
determining whether the destination address of the packet matches with a reference address saved in a database; and
sending the packet to an Ethernet terminal device if the packet matches with the reference address corresponding to the Ethernet terminal device saved in the database.
